(19) United States
(12) Patent Application Publication
(10) Pub. No.: US 2013/0300675 A1
(43) Pub. Date: Nov. 14, 2013

(54) ELECTRONIC DEVICE AND HANDWRITTEN DOCUMENT PROCESSING METHOD

(71) Applicants: Hideki Tsutsui, Tachikawa-shi (JP); Rumiko Hashiba, Kawasaki-shi (JP); Sachie Yokoyama, Ome-shi (JP); Toshihiro Fujibayashi, Hino-shi (JP); Takehiko Isaka, Hachioji-shi (JP); Takashi Sudo, Fuchu-shi (JP); Chikashi Sugiura, Hamura-shi (JP)

(72) Inventors: Hideki Tsutsui, Tachikawa-shi (JP); Rumiko Hashiba, Kawasaki-shi (JP); Sachie Yokoyama, Ome-shi (JP); Toshihiro Fujibayashi, Hino-shi (JP); Takehiko Isaka, Hachioji-shi (JP); Takashi Sudo, Fuchu-shi (JP); Chikashi Sugiura, Hamura-shi (JP)

(73) Assignee: KABUSHIKI KAISHA TOSHIBA, Tokyo (JP)

(21) Appl. No.: 13/599,570

(22) Filed: Aug. 30, 2012

(30) Foreign Application Priority Data
May 11, 2012 (JP) 2012-109831

(51) Int. Cl. G06F 3/041

(52) U.S. Cl. 345/173

(57) ABSTRACT

According to one embodiment, the electronic device displays on the screen the locus of each of a plurality of strokes which are handwritten by a handwriting input operation which is executed on the touch-screen display. The electronic device stores, in the storage medium, first time-series information including a plurality of stroke data corresponding to the plurality of strokes and indicating an order in which the plurality of strokes were handwritten. The electronic device selects the process-target time-series information part from the first time-series information in accordance with the range designation operation which is executed on the touch-screen display.

### CROSS-REFERENCE TO RELATED APPLICATIONS

This application is based upon and claims the benefit of priority from Japanese Patent Application No. 2012-109831, filed May 11, 2012, the entire contents of which are incorporated herein by reference.

### FIELD

Embodiments described herein relate generally to an electronic device which is capable of processing a handwritten document, and a handwritten document processing method which is used in the electronic device.

### BACKGROUND

In recent years, various kinds of electronic devices, such as a tablet, a PDA and a smartphone, have been developed. Most of these electronic devices include touch-screen displays for facilitating input operations by users.

By touching a menu or an object, which is displayed on the touch-screen display, by a finger or the like, the user can instruct a portable electronic device to execute a function which is associated with the menu or object.

However, most of existing electronic devices with touch-screen displays are consumer products which are designed to enhance operability on various media data such as video and music, and are not necessarily suitable for use in a business situation such as a meeting, a business negotiation or product development. Thus, in business situations, paper-based pocket notebooks have still been widely used.

Recently, the character recognition technology for recognizing characters, which are handwritten by using a tablet, etc., has been developed. Characters, which are handwritten by a user, are converted to character codes.

However, in most cases, the character recognition technology is used as a front end for generating digital document data which is composed of many character codes.

In business situations, there are cases that electronic devices are expected to function as digital tools which can support a person's thinking activities or can make easier the re-use of materials such as documents which were created in the past.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device according to an embodiment;

FIG. 2 is an exemplary view illustrating a cooperative operation between the electronic device of the embodiment and an external apparatus;

FIG. 3 is a view illustrating an example of a handwritten document which is handwritten on a touch-screen display of the electronic device of the embodiment;

FIG. 4 is an exemplary view for explaining time-series information corresponding to the handwritten document of FIG. 3, the time-series information being stored in a storage medium by the electronic device of the embodiment;

FIG. 5 is an exemplary block diagram illustrating a system configuration of the electronic device of the embodiment;

FIG. 6 is an exemplary block diagram illustrating a functional configuration of a digital notebook application program which is executed by the electronic device of the embodiment;

FIG. 7 is an exemplary flowchart illustrating the procedure of a handwritten document creation process which is executed by the electronic device of the embodiment;

FIG. 8 is an exemplary flowchart illustrating the procedure of a select process for selecting a time-series information part that is a target of processing, the select process being executed by the electronic device of the embodiment;

FIG. 9 is an exemplary view illustrating a retrieve screen which is displayed by the electronic device of the embodiment;

FIG. 10 is an exemplary view illustrating a retrieve result which is displayed on the retrieve screen of FIG. 9;

FIG. 11 is an exemplary view illustrating a state of a jump from the retrieve screen of FIG. 9 to a certain page;

FIG. 12 is an exemplary view for explaining an operation for selecting, as a retrieve query, a specific time-series information part in time-series information that is being displayed, this operation being executed by the electronic device of the embodiment;

FIG. 13 is an exemplary flowchart illustrating the procedure of a retrieve process which is executed by the electronic device of the embodiment;

FIG. 14 is an exemplary block diagram illustrating a functional configuration of a recognition process module included in the digital notebook application program of FIG. 6;

FIG. 15 is an exemplary view for explaining a recognition process for converting time-series information to paint-based application data, the recognition process being executed by the electronic device of the embodiment; and

FIG. 16 is an exemplary flowchart illustrating the procedure of the recognition process which is executed by the electronic device of the embodiment.

### DETAILED DESCRIPTION

Various embodiments will be described hereinafter with reference to the accompanying drawings.

In general, according to one embodiment, an electronic device includes a touch-screen display, a first display process module, a storage module, a second display process module and a select module. The first display process module is configured to display, on a screen of the touch-screen display, a locus of each of a plurality of strokes which are handwritten by a handwriting input operation which is executed on the touch-screen display. The storage module is configured to store, in a storage medium, first time-series information including a plurality of stroke data corresponding to the plurality of strokes and indicating an order in which the plurality of strokes were handwritten. The second display process module is configured to read out the first time-series information from the storage medium, and to display on the screen a locus corresponding to each of the plurality of strokes, based on the read-out first time-series information. The select module is configured to select a process-target time-series information part from the first time-series information in accordance with a range designation operation which is executed on the touch-screen display. The select module is configured to select, with use of the first time-series information, the process-target time-series information part from a first set of stroke data corresponding to strokes belonging to a designated range on the screen, which is designated by the range designation operation.

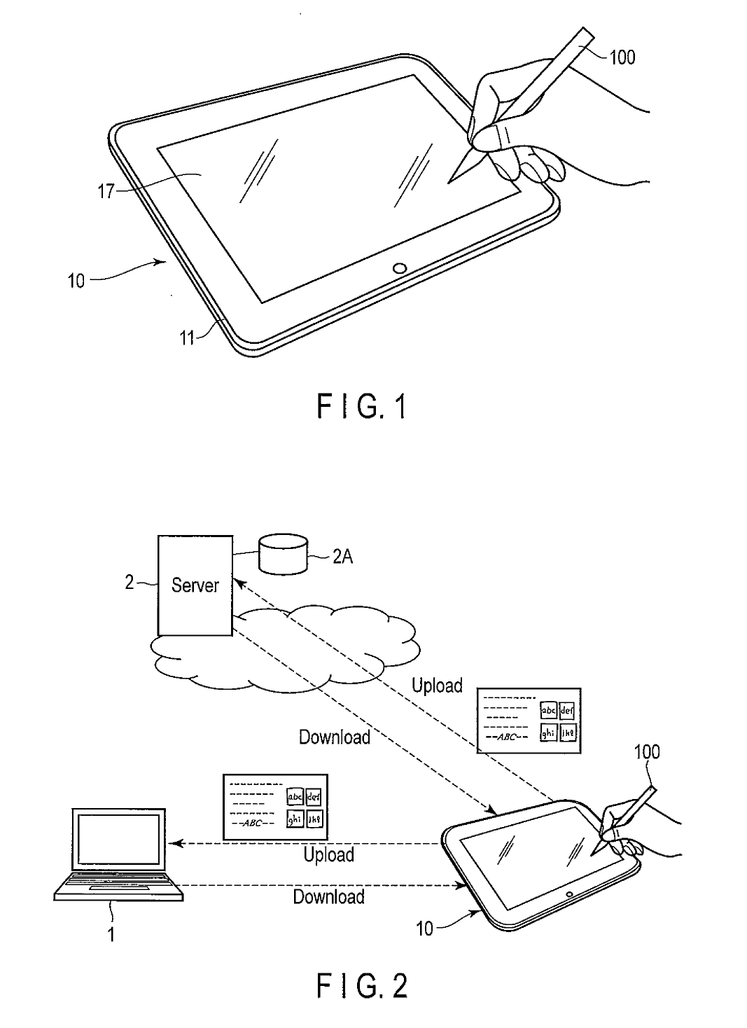

FIG. 1 is a perspective view illustrating an external appearance of an electronic device according to an embodiment. The electronic device is, for instance, a pen-based portable electronic device which can execute a handwriting input by a pen or a finger. This electronic device may be realized as a tablet computer, a notebook-type personal computer, a smartphone, a PDA, etc. In the description below, the case is assumed that this electronic device is realized as a tablet computer 10. The tablet computer 10 is a portable electronic device which is also called “tablet” or “slate computer”. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

Each of the digitizer and the touch panel is provided in a manner to cover the screen of the flat-panel display. The touch-screen display 17 can detect not only a touch operation on the screen with use of a finger, but also a touch operation on the screen with use of a pen 100. The pen 100 may be, for instance, an electromagnetic-induction pen. The user can execute a handwriting input operation on the touch-screen display 17 by using an external object (pen 100 or finger). During the handwriting input operation, a locus of movement of the external object (pen 100 or finger) on the screen, that is, a locus (a trace of writing) of a stroke that is handwritten by the handwriting input operation, is drawn in real time, and thereby the locus of each stroke is displayed on the screen. A locus of movement of the external object during a time in which the external object is in contact with the screen corresponds to one stroke. A set of many strokes corresponding to handwritten characters or graphics, that is, a set of many loci (traces of writing), constitutes a handwritten document.

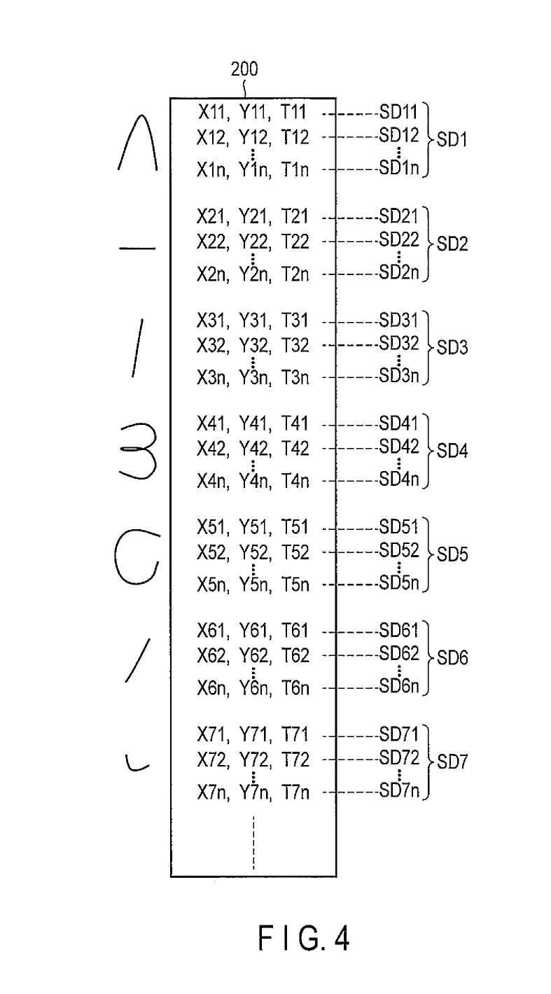

In the present embodiment, this handwritten document is stored in a storage medium not as image data but as time-series information indicative of coordinate series of the locus of each of strokes and the order relation between the strokes. The details of this time-series information will be described later with reference to FIG. 4. This time-series information indicates an order in which a plurality of strokes are handwritten, and includes a plurality of stroke data corresponding to a plurality of strokes. In other words, the time-series information means a set of time-series stroke data corresponding to a plurality of strokes. Each stroke data corresponds to one stroke, and includes coordinate data series (time-series coordinates) corresponding to points on the locus of this stroke. The order of arrangement of these stroke data corresponds to an order in which strokes are handwritten, that is, an order of strokes.

The tablet computer 10 can read out arbitrary existing time-series information from the storage medium, and can display on the screen a handwritten document corresponding to this time-series information, that is, the loci corresponding to a plurality of strokes indicated by this time-series information. Furthermore, the tablet computer 10 has an edit function. The edit function can delete or move an arbitrary stroke or an arbitrary handwritten character or the like in the displayed handwritten document, in accordance with an edit operation by the user with use of an “eraser” tool, a range select tool, and other various tools. In addition, this edit function includes a function of undoing the history of some handwriting operations.

In this embodiment, the time-series information (handwritten document) may be managed as one page or plural pages. In this case, the time-series information (handwritten document) may be divided in units of an area which falls within one screen, and thereby a piece of time-series information, which falls within one screen, may be stored as one page. Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll.

FIG. 2 shows an example of a cooperative operation between the tablet computer 10 and an external apparatus. The tablet computer 10 can cooperate with a personal computer 1 or a cloud. Specifically, the tablet computer 10 includes a wireless communication device of, e.g. wireless LAN, and can execute wireless communication with the personal computer 1. Further, the tablet computer 10 can communicate with a server 2 on the Internet. The server 2 may be a server which executes an online storage service, and other various cloud computing services.

The personal computer 1 includes a storage device such as a hard disk drive (HDD). The tablet computer 10 can transmit time-series information (handwritten document) to the personal computer 1 over a network, and can store the time-series information (handwritten document) in the HDD of the personal computer 1 (“upload”). In order to ensure a secure communication between the tablet computer 10 and personal computer 1, the personal computer 1 may authenticate the tablet computer 10 at a time of starting the communication. In this case, a dialog for prompting the user to input an ID or a password may be displayed on the screen of the tablet computer 10, or the ID of the tablet computer 10, for example, may be automatically transmitted from tablet computer 10 to the personal computer 1.

Thereby, even when the capacity of the storage in the tablet computer 10 is small, the tablet computer 10 can handle many time-series information items (many handwritten documents) or large-volume time-series information (large-volume handwritten document).

In addition, the tablet computer 10 can read out (“download”) one or more arbitrary time-series information items stored in the HDD of the personal computer 1, and can display the locus of each of strokes indicated by the read-out time-series information on the screen of the display 17 of the tablet computer 10. In this case, the tablet computer 10 may display on the screen of the display 17 a list of thumbnails which are obtained by reducing in size pages of plural time-series information items (handwritten documents), or may display one page, which is selected from these thumbnails, on the screen of the display 17 in the normal size.

Furthermore, the destination of communication of the tablet computer 10 may be not the personal computer 1, but the server 2 on the cloud which provides storage services, etc., as described above. The tablet computer 10 can transmit time-series information (handwritten document) to the server 2 over the network, and can store the time-series information (handwritten document) in a storage device 2A of the server 2 (“upload”). Besides, the tablet computer 10 can read out arbitrary time-series information which is stored in the storage device 2A of the server 2 (“download”) and can display the locus of each stroke, which is indicated by this time-series information, on the screen of the display 17 of the tablet computer 10.

As has been described above, in the present embodiment, the storage medium in which the time-series information is stored may be the storage device in the tablet computer 10, the storage device in the personal computer 1, or the storage device in the server 2.

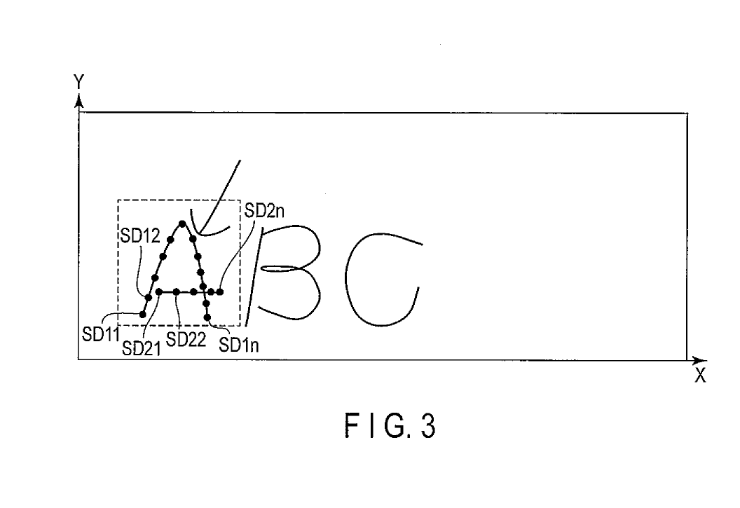

Next, referring to FIG. 3 and FIG. 4, a description is given of a relationship between strokes (characters, marks, graphics, tables, etc.), which are handwritten by the user, and time-series information. FIG. 3 shows an example of a handwritten document (handwritten character string) which is handwritten on the touch-screen display 17 by using the pen 100 or the like.

In many cases, on a handwritten document, other characters or graphics are handwritten over already handwritten characters or graphics. In FIG. 3, the case is assumed that a handwritten character string “ABC” was handwritten in the order of “A”, “B” and “C”, and thereafter a handwritten arrow was handwritten near the handwritten character “A”.

The handwritten character “A” is expressed by two strokes (a locus of “̂” shape, a locus of “-” shape) which are handwritten by using the pen 100 or the like, that is, by two loci. The locus of the pen 100 of the first handwritten “̂” shape is sampled in real time, for example, at regular time intervals, and thereby time-series coordinates SD11, SD12, . . . , SD1n of the stroke of the “̂” shape are obtained. Similarly, the locus of the pen 100 of the next handwritten “-” shape is sampled in real time, for example, at regular time intervals, and thereby time-series coordinates SD21, SD22, . . . , SD2n of the stroke of the “-” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten “arrow” is expressed by two strokes which are handwritten by using the pen 100 or the like, that is, by two loci.

FIG. 4 illustrates time-series information 200 corresponding to the handwritten document of FIG. 3. The time-series information 200 includes a plurality of stroke data SD1, SD2, . . . , SD7. In the time-series information 200, the stroke data SD1, SD2, . . . , SD7 are arranged in time series in the order of strokes, that is, in the order in which plural strokes are handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”. The sixth and seventh stroke data SD6 and SD7 are indicative of two strokes which constitute the handwritten “arrow”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the handwritten “̂” shape of the handwritten character “A”, that is, an n-number of coordinate data SD11, SD12, . . . , SD1n. The stroke data SD2 includes coordinate data series corresponding to the points on the locus of the stroke of the handwritten “-” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “̂” shape. The coordinate data SD1n is indicative of an X coordinate (X1n) and a Y coordinate (Y1n) of the end point of the stroke of the “̂” shape.

Further, each coordinate data may include time stamp information T corresponding to a time point at which a point corresponding to this coordinate data was handwritten. The time point at which the point was handwritten may be either an absolute time (e.g. year/month/date/hour/minute/second) or a relative time with reference to a certain time point. For example, an absolute time (e.g. year/month/date/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be more precisely expressed.

Moreover, information (Z) indicative of a pen stroke pressure may be added to each coordinate data.

The time-series information 200 having the structure as described with reference to FIG. 4 can express not only the trace of handwriting of each stroke, but also the temporal relation between strokes. Thus, with the use of the time-series information 200, even if a distal end portion of the handwritten “arrow” is written over the handwritten character “A” or near the handwritten character “A”, as shown in FIG. 3, the handwritten character “A” and the distal end portion of the handwritten “arrow” can be treated as different characters or graphics.

The case is now assumed that a certain range on the screen has been designated by the user, as indicated by a broken-line rectangle in FIG. 3. The designated range indicated by the broken-line rectangle includes two strokes of the handwritten character “A” and one stroke corresponding to the distal end portion of the handwritten “arrow”. Thus, in usual cases, it is possible that not only the two strokes of the handwritten character “A” but also the one stroke corresponding to the distal end portion of the handwritten “arrow” is selected as a time-series information part that is the target of processing.

However, in the present embodiment, with the use of the time-series information 200, the distal end portion of the handwritten “arrow” can be excluded from the time-series information part that is the target of processing. Specifically, in the present embodiment, the time-series information 200 is analyzed, and thereby it is determined that the two strokes (stroke data SD1 and SD2) of the handwritten character “A” were successively handwritten, and it is also determined that the handwriting timing of the distal end portion (stroke data SD7) of the handwritten “arrow” is not successive to the handwriting timing of the handwritten character “A”. Therefore, the distal end portion (stroke data SD7) of the handwritten “arrow” can be excluded from the time-series information part that is the target of processing. In this case, the determination as to whether the handwriting timing of the distal end portion (stroke data SD7) of the handwritten “arrow” is non-successive to the handwriting timing of the handwritten character “A” can be executed based on the arrangement of stroke data in the time-series information 200.

For example, in the time-series information 200 of FIG. 4, since many stroke data corresponding to many strokes are present between the stroke data SD2 and stroke data SD7, it can be determined that the handwriting timing of the stroke data SD7 is not successive to the handwriting timing of the stroke data SD2.

Alternatively, this determination process may be executed by using the above-described time stamp information T, instead of using the arrangement of stroke data in the time-series information 200. By using the time stamp information T, it is possible to execute the above-described determination process with a higher precision than in the case of using the arrangement of stroke data. For example, based on the difference between the time stamp information of the stroke data SD2 and the time stamp information of the stroke data SD7, it may be determined whether the handwriting timing of the stroke data SD7 and the handwriting timing of the stroke data SD2 are non-successive (temporally non-successive) or not, that is, whether the time distance between the handwriting timing of the stroke data SD7 and the handwriting timing of the stroke data SD2 is a predetermined time or more.

In this manner, by using in the above-described determination process the time stamp information corresponding to each of strokes (a first set of strokes) belonging to a designated range, it is possible to easily exclude a stroke of the first set of strokes, the handwriting timing of which is not successive (not temporally successive) to the handwriting timing of other strokes, from the time-series information part that is the target of processing.

For example, the case is now assumed that the “arrow” in FIG. 3 was handwritten not after the handwriting of character string “ABC” but after the handwriting of character “A”. If the stroke corresponding to the distal end portion of the “arrow” was handwritten subsequent to the stroke of the “-” shape, it would be possible that the stroke data SD7 corresponding to the distal end portion of the “arrow” is disposed immediately below the stroke data SD2 corresponding to the “-” shape.

Even in such a case, by executing the above-described determination process by using the time stamp information T corresponding to each of the strokes belonging to the designated range, the distal end portion of the handwritten “arrow” can be excluded from the time-series information part that is the target of processing. The reason for this is that in the same character, in usual cases, the difference between the handwriting timings of two strokes, which are successive in the stroke order, is shorter than a certain reference time. On the other hand, between different characters, in many cases, the difference between the handwriting timings of two successive strokes is relatively large.

Accordingly, in the case where the distal end portion of the “arrow” was handwritten after the handwriting of character “A” as described above, the difference between the time stamp information of the stroke data SD1 of the “̂” shape and time stamp information of the stroke data SD2 of the “-” shape is small, but the difference between the time stamp information of the stroke data SD2 of the “-” shape and the stroke data SD7 corresponding to the distal end portion of the “arrow” is large.

Thus, even if the stroke corresponding to the distal end portion of the “arrow” is handwritten subsequent to the stroke of the “-” shape, that is, even if the stroke data SD1, SD2 and SD7 belonging to the designated range are disposed close to each other in the time-series information 200, it is possible to determine that the handwriting timing of the distal end portion (stroke data SD7) of the “arrow” is not (temporally) successive to the handwriting timing of the stroke of the “-” shape of the handwritten character “A”, for example, by comparing the time stamp information of the stroke data SD2 and the time stamp information of the stroke data SD7.

In the meantime, as the time stamp information of the stroke data SD1, use may be made of an arbitrary one selected from among a plurality of time stamp information items T11 to T1n corresponding to a plurality of coordinates in the stroke data SD1, or a mean value of the time stamp information items T11 to T1n. Similarly, as the time stamp information of the stroke data SD2, use may be made of an arbitrary one selected from among a plurality of time stamp information items T21 to T2n corresponding to a plurality of coordinates in the stroke data SD2, or a mean value of the time stamp information items T21 to T2n. In addition, similarly, as the time stamp information of the stroke data SD7, use may be made of an arbitrary one selected from among a plurality of time stamp information items T71 to T7n corresponding to a plurality of coordinates in the stroke data SD7, or a mean value of the time stamp information items T71 to T7n.

Alternatively, in the above-described determination process between two successive stroke data, it is possible to compare the time stamp information corresponding to the last coordinate point of the preceding stroke and the time stamp information corresponding to the first coordinate point of the following stroke. For example, when the stroke data SD2 and stroke data SD7 are disposed close to each other, it is possible to compare the time stamp information T2n corresponding to the last coordinate point of the stroke data SD2 and the time stamp information T71 corresponding to the first coordinate point of the stroke data SD7.

Besides, the above-described determination process may be executed based on both the arrangement of stroke data in the time-series information and the time stamp information T corresponding to each of the stroke data.

For example, when a predetermined number or more of stroke data are included between the stroke data SD2 and stroke data SD7, it may immediately be determined that the handwriting timing of the stroke data SD7 is not successive to the handwriting timing of the stroke data SD2. When the number of stroke data between the stroke data SD2 and stroke data SD7 is less than the predetermined number, it may be determined, based on the time stamp information in the stroke data SD2 and the time stamp information in the stroke data SD7, whether the handwriting timing of the stroke data SD7 and the handwriting timing of the stroke data SD2 are non-successive or not.

In this case, it is possible to compare the time stamp information T2n which is added to the last coordinate data in the stroke data SD2 and the time stamp information T71 which is added to the first coordinate data in the stroke data SD7.

In addition, in the time-series information 200 of the present embodiment, as described above, the arrangement of stroke data SD1, SD2, . . . , SD7 indicates the order of strokes of handwritten characters. For example, the arrangement of stroke data SD1 and SD2 indicates that the stroke of the “̂” shape was first handwritten and then the stroke of the “-” shape was handwritten. Thus, even when the traces of writing of two handwritten characters are similar to each other, if the orders of strokes of the two handwritten characters are different from each other, these two handwritten characters can be distinguished as different characters.

Furthermore, in the present embodiment, as described above, a handwritten document is stored not as an image or a result of character recognition, but as the time-series information 200 which is composed of a set of time-series stroke data. Thus, handwritten characters can be handled, without depending on languages of the handwritten characters. Therefore, the structure of the time-series information 200 of the present embodiment can be commonly used in various countries of the world where different languages are used.

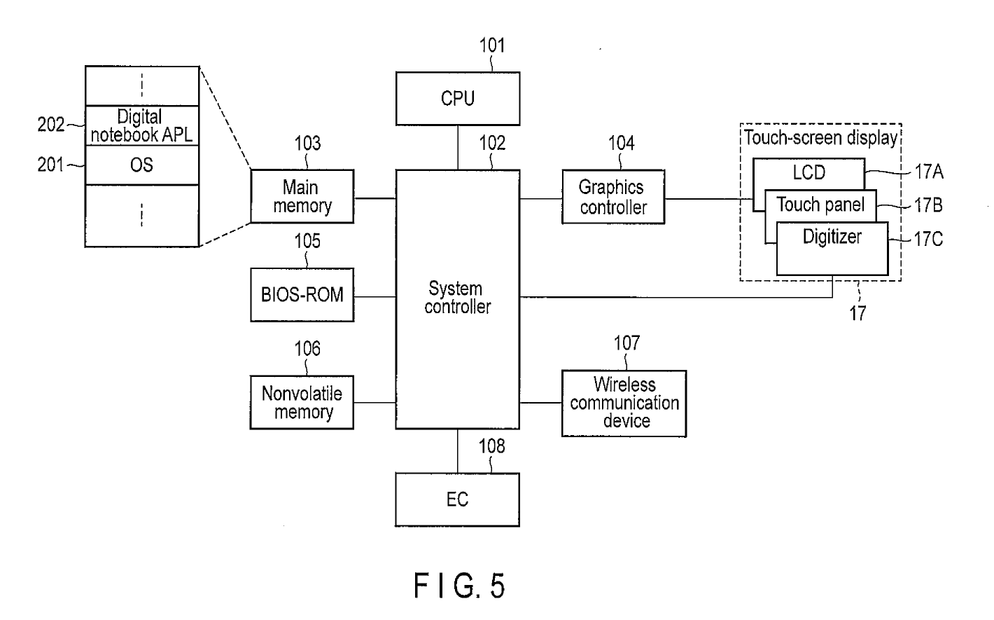

FIG. 5 shows a system configuration of the tablet computer 10.

As shown in FIG. 5, the tablet computer 10 includes a CPU 101, a system controller 102, a main memory 103, a graphics controller 105, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a digital notebook application program (digital notebook APL) 202. The digital notebook application program 202 includes a function of creating and displaying the above-described handwritten document, a function of editing the handwritten document, a handwriting retrieve function, and a character/graphic recognition function.

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B and a digitizer 17C are disposed on the LCD 17A. The touch panel 17B is an electrostatic capacitance-type pointing device for executing an input on the screen of the LCD 17A. A contact position on the screen, which is touched by a finger, and a movement of the contact position, are detected by the touch panel 17B. The digitizer 17C is an electromagnetic induction-type pointing device for executing an input on the screen of the LCD 17A. A contact position on the screen, which is touched by the pen 100, and a movement of the contact position, are detected by the digitizer 17C.

The wireless communication device 107 is a device configured to execute wireless communication such as wireless LAN or 3G mobile communication. The EC 108 is a one-chip microcomputer including an embedded controller for power management. The EC 108 includes a function of power on or power off the tablet computer 10 in accordance with an operation of a power button by the user.

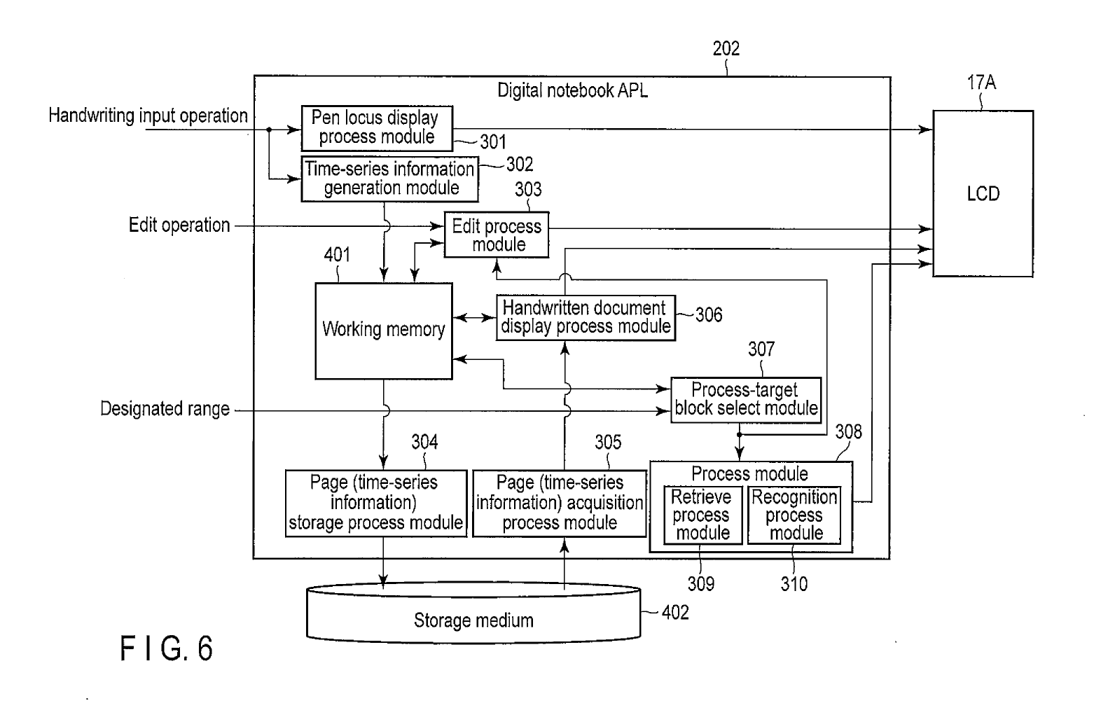

Next, referring to FIG. 6, a description is given of a functional configuration of the digital notebook application program 202.

The digital notebook application program 202 includes a pen locus display process module 301, a time-series information generation module 302, an edit process module 303, a page storage process module 304, a page acquisition process module 305, a handwritten document display process module 306, a process-target block select module 307, and a process module 308.

The digital notebook application program 202 executes creation, display and edit of a handwritten document, by using stroke data which is input by using the touch-screen display 17. The touch-screen display 17 is configured to detect the occurrence of events such as “touch”, “movement (slide)” and “release”. The “touch” is an event indicating that an external object has come in contact with the screen. The “move (slide)” is an event indicating that the position of contact of the external object has been moved while the external object is in contact with the screen. The “release” is an event indicating that the external object has been released from the screen.

The pen locus display process module 301 and time-series information generation module 302 receive an event “touch” or “move (slide)” which is generated by the touch-screen display 17, thereby detecting a handwriting input operation. The “touch” event includes coordinates of a contact position. The “move (slide)” event also includes coordinates of a contact position at a destination of movement. Thus, the pen locus display process module 301 and time-series information generation module 302 can receive coordinate series, which correspond to the locus of movement of the contact position, from the touch-screen display 17.

The pen locus display process module 301 receives coordinate series from the touch-screen display 17 and displays, based on the coordinate series, the locus of each stroke, which is handwritten by a handwriting input operation with use of the pen 100 or the like, on the screen of the LCD 17A in the touch-screen display 17. By the pen locus display process module 301, the locus of the pen 100 during a time in which the pen 100 is in contact with the screen, that is, the locus of each stroke, is drawn on the screen of the LCD 17A.

The time-series information generation module 302 receives the above-described coordinate series which are output from the touch-screen display 17, and generates, based on the coordinate series, the above-described time-series information having the structure as described in detail with reference to FIG. 4. In this case, the time-series information, that is, the coordinates and time stamp information corresponding to the respective points of each stroke, may be temporarily stored in a working memory 401.

The page storage process module 304 stores the generated time-series information as a handwritten document (handwritten page) in a storage medium 402. The storage medium 402, as described above, may be the storage device in the tablet computer 10, the storage device in the personal computer 1, or the storage device in the server 2.

The page acquisition process module 305 reads out from the storage medium 402 arbitrary time-series information which is already stored in the storage medium 402. The read-out time-series information is sent to the handwritten document display process module 306. The handwritten document display process module 306 analyzes the time-series information and displays, based on the analysis result, the locus of each stroke indicated by the time-series information on the screen as a handwritten page.

The edit process module 303 executes a process for editing a handwritten page which is currently being displayed. Specifically, in accordance with an edit operation which is executed by the user on the touch-screen display 17, the edit process module 303 executes an edit process for deleting or moving one or more strokes of a plurality of stokes which are being displayed. Further, the edit process module 303 updates the time-series information which is being displayed, in order to reflect the result of the edit process on the time-series information.

The user can delete an arbitrary stroke of the plural strokes which are being displayed, by using an “eraser” tool, etc. In addition, the user can designate a range of an arbitrary part in the time-series information (handwritten page) which is being displayed, by using a “range designation” tool for surrounding an arbitrary part on the screen by a circle or a rectangle. In accordance with the designated range on the screen, which is designated by this range designation operation, a time-series information part that is the target of processing, that is, a set of strokes that are the target of processing, is selected by the process-target block select module 307. Specifically, by using the time-series information which is being displayed, the process-target block select module 307 selects a process-target time-series information part from among a first set of stroke data corresponding to strokes belonging to the designated range.

For example, the process-target block select module 307 extracts, from the time-series information which is being displayed, the first set of stroke data corresponding to strokes belonging to the designated range, and determines, as a process-target time-series information part, the respective stroke data in the first set of stroke data, from which second stroke data that is not successive in time series to other stroke data in the first set of stroke data is excluded.

When a menu such as “delete” or “move” has been selected from the edit menu by the user, the edit process module 303 executes a process of delete or move on the set of stroke data which has been selected by the process-target block select module 307. In this case, when plural stroke data are selected as the set of stroke data that is the target of processing, the edit process module 303 can delete the plural stroke data as a whole from the screen, or can move the plural stroke data as a whole to another position on the screen. In the time-series information, the time-series coordinates of each moved stroke data may automatically be changed in accordance with a destination position of movement. In addition, an operation history, which indicates that the time-series coordinates of each moved stroke data have been changed, may be added to the time-series information. Each deleted stroke data may not necessarily be deleted from the time-series coordinates, and an operation history, which indicates that each stroke data has been deleted, may be added to the time-series information.

The process module 308 can execute various processes, for example, a handwriting retrieve process and a recognition process, on the process-target time-series information. The process module 308 includes a retrieve process module 309 and a recognition process module 310.

The retrieve process module 309 searches a plurality of time-series information items (a plurality of handwritten pages) which are already stored in the storage medium 402, and retrieves a specific time-series information part (e.g. a specific handwritten character string) of these plural time-series information items. The retrieve process module 309 includes a designation module configured to designate a specific time-series information part as a retrieve key, that is, a retrieve query. The retrieve process module 309 retrieves, from each of the plural time-series information items, a time-series information part having the locus of a stroke, the degree of similarity of which to the locus of a stroke corresponding to the specific time-series information part is a reference value or more, and the retrieve process module 309 visually recognizably displays the locus corresponding to the retrieved time-series information part on the screen of the LCD 17A.

For example, as the specific time-series information part which is designated as the retrieve query, use may be made of, for example, a specific handwritten character, a specific handwritten character string, a specific handwritten symbol, or a specific handwritten graphic. In the description below, the case is assumed that a specific handwritten character string is designated as the retrieve query.

The retrieve process, which is executed by the retrieve process module 309, is a handwriting retrieve, and a handwritten character string having a trace of writing, which is similar to the specific handwritten character string that is the retrieve query, is retrieved from a plurality of plural handwritten pages which are already stored. In the meantime, a handwriting retrieve may be executed with respect to only one handwritten page which is being currently displayed.

Various methods are usable as the method of calculating the degree of similarity between handwritten characters. For example, coordinate series of each stroke may be treated as a vector. In this case, in order to calculate the degree of similarity between vectors which are targets of comparison, an inner product between the vectors which are targets of comparison may be calculated as the degree of similarity between the vectors which are targets of comparison. In another example, the locus of each stroke may be treated as an image, and the area of a part, where images of loci of targets of comparison overlap to a highest degree, may be calculated as the above-described degree of similarity. Furthermore, an arbitrary device may be made for reducing the amount of computation processing. Besides, DP (Dynamic Programming) matching may be used as the method of calculating the degree of similarity between handwritten characters.

The above-described designation module in the retrieve process module 309 may display on the screen a retrieve key input area for handwriting a character string or a graphic which is to be set as the target of retrieval. A character string or the like, which has been handwritten in the retrieve key input area by the user, is used as the retrieve query.

Alternatively, as the designation module, the above-described process-target block select module 307 may be used. In this case, the process-target block select module 307 can select a specific time-series information part in the displayed time-series information as a character string or a graphic which is to be set as the target of retrieval, in accordance with a range designation operation which is executed by the user. The user may designate a range in a manner to surround a character string that is a part of a displayed page, or may newly handwrite a character string for a retrieve query on a margin of a displayed page and may designate a range in a manner to surround the character string for the retrieve query.

For example, the user can designate the range by surrounding a part in a displayed page by a circle. Alternatively, the user may set the digital notebook application program 202 in a “select” mode by using a pre-prepared menu, and then the user may trace a part in a displayed page by the pen 100.

In this manner, when the time-series information part (handwritten character string) in the time-series information (handwritten page) that is being displayed has been selected as the retrieve query, the retrieve process module 309 excludes the time-series information part, which has been selected as the retrieve query, from the target of retrieval. Specifically, the retrieve process module 309 retrieves a certain time-series information part from the other time-series information part in the displayed time-series information excluding the selected time-series information part. The certain time-series information part has a locus of a stroke, a degree of similarity of which to a locus of a stroke corresponding to the selected time-series information part is a reference value or more.

By executing the process of excluding the time-series information part selected as the retrieve query from the target of retrieval, as described above, it becomes possible to prevent the selected time-series information part itself (i.e. a character string that is retrieved as a matter of course) from being displayed as a retrieve result.

Thus, the user can input a retrieve query by newly handwriting a character string, which is to be used as the retrieve query, on a page that is being displayed, and selecting this character string. In this case, since the newly handwritten character string (retrieve query) itself is excluded from the target of retrieval, the newly handwritten character string itself is not displayed as the retrieve result. Therefore, without displaying a retrieve key input area on the screen, a part of a handwritten page that is being displayed can easily be used as a retrieve query.

As has been described above, in the present embodiment, a handwritten character, which is similar to the characteristic of a certain handwritten character that has been selected as a retrieve query, can be retrieved from plural handwritten pages which have already been stored. Therefore, a handwritten page, which meets the user's intention, can easily be retrieved from many handwritten pages which were created and stored in the past.

In the handwriting retrieve of the embodiment, character recognition does not need to be executed, unlike the case of text retrieve. Thus, the handwriting retrieve of the embodiment does not depend on languages, and handwritten pages which are handwritten in any language can be set to be the target of retrieval. Moreover, graphics, etc. can be used as a retrieve query for handwriting retrieve, and symbols, marks, etc. other than languages, can be used as a retrieve query for handwriting retrieve.

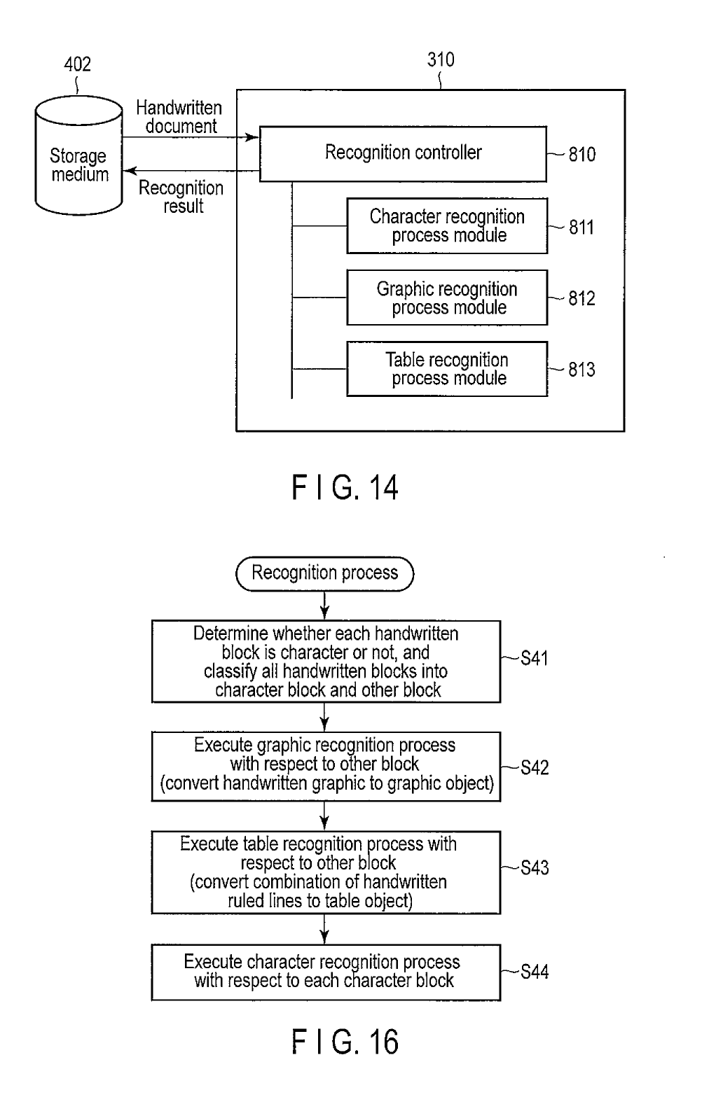

The recognition process module 310 executes a recognition process, such as handwritten character recognition, handwritten graphic recognition or handwritten table recognition, on the time-series information (handwritten page) that is being displayed. This recognition process can be used for converting a handwritten page to application data having a structure which can be handled by a paint-based application program, etc. The details of the recognition process module 310 will be described later with reference to FIG. 14.

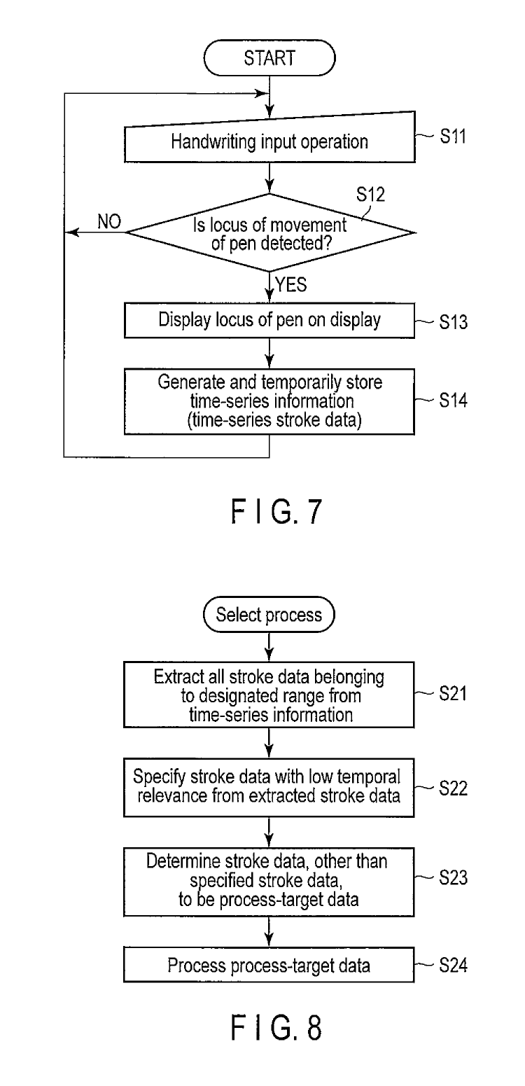

Next, referring to a flowchart of FIG. 7, description is given of the procedure of a handwritten page creation process which is executed by the digital notebook application program 202.

If the user executes a handwriting input operation by using the pen 100 (step S11), an event of “touch” or “move” occurs. Based on the event, the digital notebook application program 202 detects a locus of movement of the pen 100 (step S12). If the locus of movement of the pen 100 is detected (YES in step S12), the digital notebook application program 202 displays the detected locus of movement of the pen 100 on the display (step S13). Further, the digital notebook application program 202 generates the above-described time-series information, based on the coordinate series corresponding to the detected locus of movement of the pen 100, and temporarily stores the time-series information in the working memory 401 (step S14).

Next, referring to a flowchart of FIG. 8, a description is given of the procedure of a select process which is executed by the process-target block select module 307 of the digital notebook application program 202.

The case is now assumed that a handwritten document is displayed based on certain time-series information. In accordance with a range designation operation by the user, the process-target block select module 307 selects a time-series information part that is a target of processing, from the time-series information. In the process of selecting the process-target time-series information part, the process-target block select module 307 selects, with use of the time-series information, the process-target time-series information part, that is, one or more stroke data that are to be set as the target of processing, from all the stroke data belonging to the designated range on the screen. This select process, as described above, can be executed based on the continuity between stroke data belonging to the designated range.

Specifically, the process-target block select module 307 first extracts, from the time-series information that is displayed, all stroke data belonging to the designated range on the screen, which is designated by the range designation operation by the user (step S21). The extraction process of step S21 is executed based on the time-series coordinates corresponding to each stroke data in the time-series information.

Subsequently, the process-target block select module 307 specifies stroke data having a low degree of temporal relevance, from the set of extracted stroke data, based on the arrangement between the extracted stroke data and the time stamp information that is added to each coordinate data in each extracted stroke data (step S22).

The stroke data having a low degree of temporal relevance, as described above, means stroke data whose handwriting timing is not successive to the handwriting timing of other stroke data in the set of extracted stroke data.

The case is now assumed that a process is executed for determining whether first stroke data in the set of extracted stroke data is the above-described non-successive stroke data. In this case, to begin with, second stroke data, the handwriting timing of which is closest to the handwriting timing of the first stroke data, is specified from the set of extracted stroke data. Then, it is determined whether the number of strokes, which exist between the second stroke data and the first stroke data, is a predetermined reference stroke number or more, or whether a difference (time distance) between the time stamp information of the second stroke data and the time stamp information of the first stroke data is a predetermined reference time or more. Based on the determination result, it is determined whether the first stroke data is the above-described non-successive stroke data.

The process-target block select module 307 determines all the extracted stroke data, excluding the specified stroke data (non-successive stroke data), to be the process-target data (step S23). Then, a predetermined process is executed on each stroke data which has been determined to be the process-target data (step S24).

The case is assumed that a rectangle of a broken line in FIG. 3 has been designated by a range designation operation by the user. To start with, stroke data SD1, SD2 and SD7 in FIG. 4 are extracted as stroke data belonging to the designated range indicated by the broken-line rectangle in FIG. 3. The handwriting timings of the stroke data SD1 and SD2 are successive to each other, but the handwriting timing of the stroke data SD7 is not successive to the handwriting timing of the stroke data SD2. Accordingly, the stroke data SD7 is specified as the above-described non-successive stroke data.

In the above case, the non-successive stroke data is specified by using the reference stroke number or reference time. However, the non-successive stroke data may be specified by using other methods. For example, all stroke data existing in the designated range may be grouped into two or more blocks, so that stroke data corresponding to handwritten strokes, which are disposed close to each other and successive to each other, may be classified into the same block. Then, an overlapping area between each block and the designated range is calculated, and each of stroke data included in each of the blocks other than the block having the maximum overlapping area may be specified as non-successive stroke data.

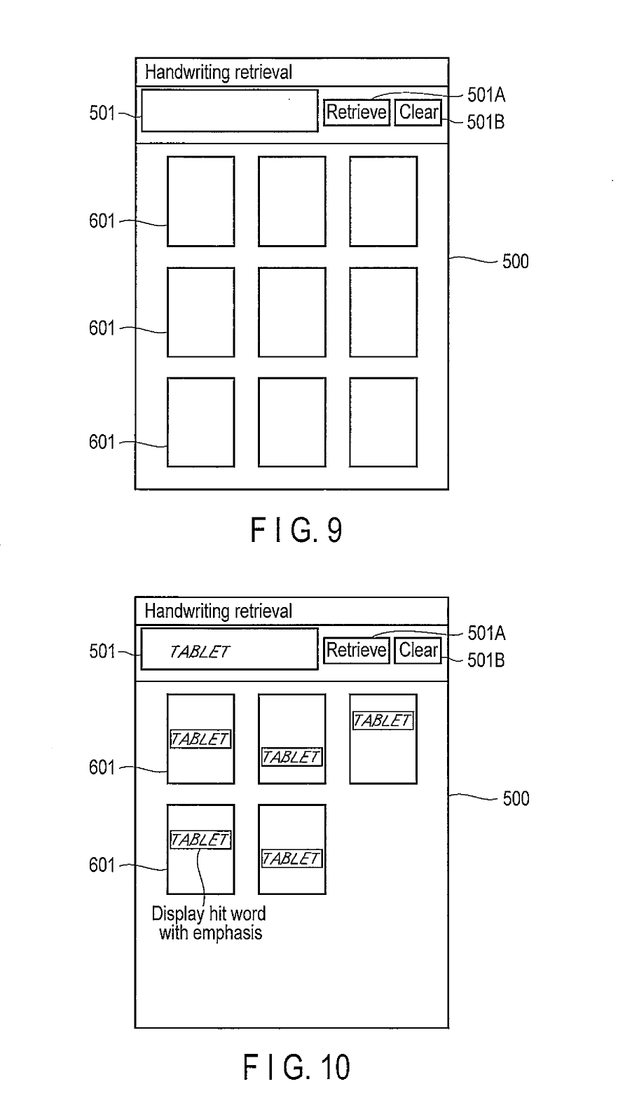

FIG. 9 illustrates a handwriting retrieve screen 500 which is presented to the user by the digital notebook application program 202.

The handwriting retrieve screen 500 displays a retrieve key input area 501, a retrieve button 501A and a clear button 501B. The retrieve key input area 501 is an input area for handwriting a character string or a graphic which is to be set as a target of retrieval. The retrieve button 501A is a button for instructing execution of a handwriting retrieve process. The clear button 501B is a button for instructing deletion (clear) of the handwritten character string or graphic in the retrieve key input area 501.

The handwriting retrieve screen 500 further displays a plurality of handwritten page thumbnails 601. In the example of FIG. 9, nine handwritten page thumbnails 601 corresponding to nine handwritten pages are displayed.

As shown in FIG. 10, when the retrieve button 501A has been pressed in the state in which a handwritten character string “TABLET” is input in the retrieve key input area 501, a handwriting retrieve process is started for retrieving a handwritten character string “TABLET” from each of the nine handwritten pages. Then, handwritten page thumbnails corresponding to some handwritten pages including the handwritten character string “TABLET” are displayed. FIG. 10 illustrates the case in which five handwritten pages of the nine handwritten pages have been retrieved as handwritten pages including the handwritten character string “TABLET”. Hit words, that is, the handwritten character strings “TABLET” in the five handwritten page thumbnails, are displayed with emphasis.

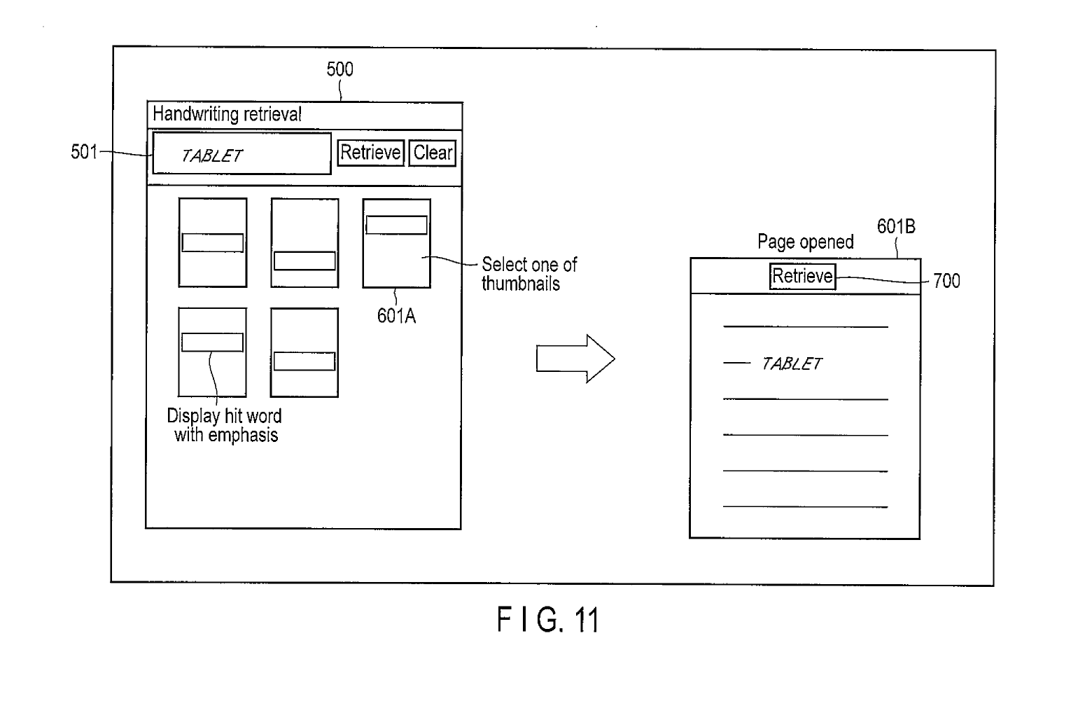

When one of the five retrieved handwritten page thumbnails has been selected by the user, as shown in FIG. 11, a handwritten page 601B corresponding to a selected handwritten page thumbnail 601A is displayed on the screen with the normal size. A retrieve button 700 is displayed on the handwritten page 601B. If the retrieve button 700 has been pressed by the user, the content of the display screen is restored to the retrieve screen, which is shown in the left part of FIG. 11.

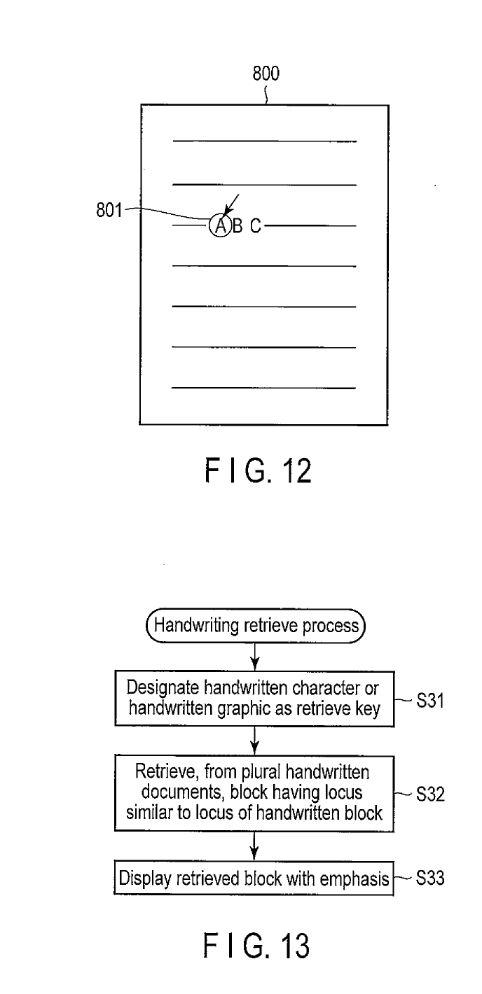

FIG. 12 illustrates an example in which a part of a displayed handwritten page 800 is used as a character string or graphic that is to be set as a target of retrieval. By encircling a part of the handwritten page 800, for example, by a handwritten circle 801, the user can execute range designation of this part of the handwritten page 800. Although the handwritten circle 801 includes a handwritten character “A” and a distal end portion of a handwritten arrow, the distal end portion of the handwritten arrow can be excluded from the target of processing, as described above. Thus, the handwritten character “A” can be designated as the character that is to be set as the target of retrieval.

Next, referring to a flowchart of FIG. 13, the procedure of the above-described handwriting retrieval process is described.

In accordance with a user operation, the digital notebook application program 202 designates a handwritten block (time-series information part), for instance, a handwritten character string or a handwritten graphic, as a retrieve key (retrieve query) (step S31). Then, the digital notebook application program 202 retrieves, from a plurality of handwritten documents (handwritten pages), a handwritten block having a locus of a stroke, the degree of similarity of which to the locus of a stroke in the handwritten block that is designated as the retrieve key is a reference value or more (step S32). The retrieved handwritten block is displayed with emphasis (step S33).

FIG. 14 illustrates a structure example of the recognition process module 310.

The recognition process module 310 includes a recognition controller 810, a character recognition process module 811, a graphic recognition process module 812, and a table recognition process module 813. The recognition controller 810 is a module for controlling the three recognition modules, namely the character recognition process module 811, graphic recognition process module 812 and table recognition process module 813.

The character recognition process module 811 character-recognizes each of a plurality of blocks (handwriting blocks) which are obtained by executing a grouping process of a plurality of stroke data indicated by the time-series information of the target of the recognition process, and converts each of handwritten characters in the plural blocks to a character code. In the grouping process, the plural stroke data, which are indicated by the time-series information of the target of the recognition process, are grouped so that stroke data corresponding to strokes, which are located close to each other and are successively handwritten, may be classified into the same block.

The graphic recognition process module 812 executes a graphic recognition process for converting a process-target block of the plural blocks, which are obtained by executing the above-described grouping process of the plurality of stroke data indicated by the time-series information of the target of the recognition process, to one of a plurality of graphic objects. A handwritten graphic included in the handwritten document (handwritten page) is converted to a graphic object which can be handled by a paint-based application program such as PowerPoint®. The graphic recognition process module 812 stores in advance, for example, graphic information indicative of characteristics of a plurality of graphic objects, and calculates the degree of similarity between the handwritten graphic and the plurality of graphic objects. Then, the handwritten graphic is converted to a graphic object having a highest degree of similarity to this handwritten graphic.

In the calculation of the degree of similarity, the handwritten graphic may be rotated, enlarged or reduced, where necessary. The degrees of similarity between the handwritten graphic, which has been rotated, enlarged or reduced, and the plural graphic objects are obtained. Then, a graphic object having a highest degree of similarity to the handwritten graphic is selected, and the selected graphic object is deformed based on the content of processing of rotation, enlargement or reduction, which has been executed on the handwritten graphic. This deformed graphic object is displayed in place of the handwritten graphic.

In the above-described calculation of the degree of similarity, each of the locus information of the stroke of the handwritten graphic and the locus information of each graphic object can be treated as a set of vectors, and the sets of vectors can be compared to calculate the degree of similarity. Thereby, a handwritten graphic can easily be converted to a paint-based document (application data) of, e.g. PowerPoint®.

The table recognition process module 813 recognizes whether a process-target block of the plural blocks, which are obtained by executing the above-described grouping process of the plurality of stroke data indicated by the time-series information of the target of the recognition process, is a table shape including a combination of some line-shaped loci. When it is recognized that the process-target block is a table shape, the table recognition process module 813 converts the process-target block to a table object having the same numbers of vertical and horizontal elements as the numbers of vertical and horizontal elements of the recognized table shape.

A handwritten table included in the handwritten document (handwritten page) is converted to a table object which can be handled by a spreadsheet application program such as Excel®. The table recognition process module 813 recognizes a combination of vertical and horizontal lines in the handwritten document, and recognizes that this combination is in the state of a table. In the process of conversion to the table object, each handwritten element in the handwritten table may directly be input as handwritten data to the elements in the table object. Alternatively, a character code, which is obtained by character-recognizing each handwritten element in the handwritten table, may be input to the elements in the table object.

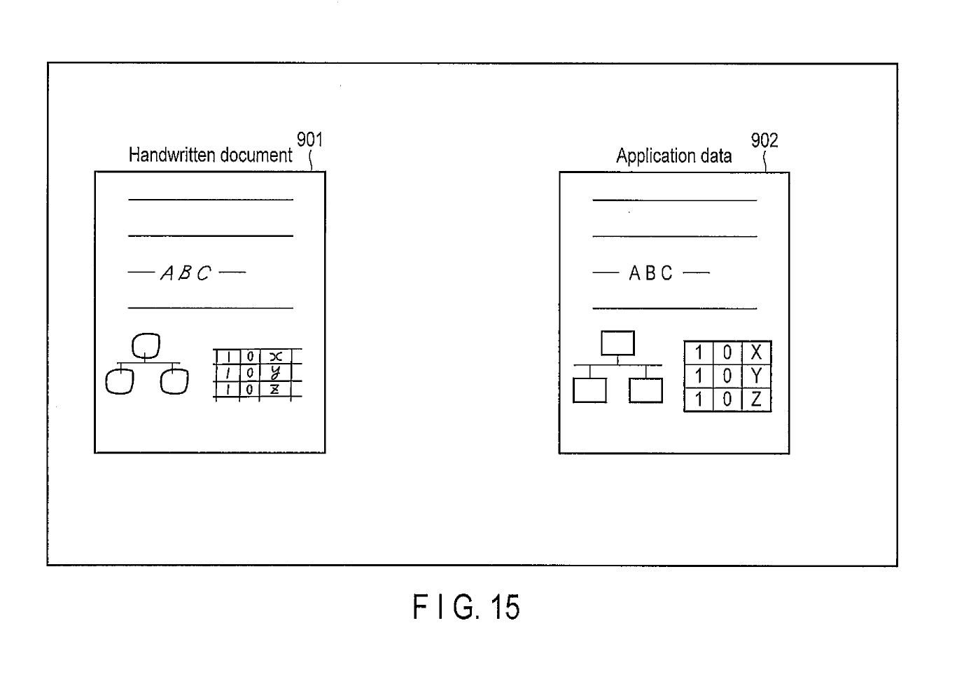

FIG. 15 illustrates a process of converting a handwritten page 901 to data 902 of a paint-based application such as PowerPoint®. The handwritten page 901 includes a handwritten character string, a handwritten graphic, and a handwritten table. The handwritten character string, handwritten graphic and handwritten table are converted to a character code, a graphic object and a table object, respectively, and thereby the data 902 of the paint-based application is obtained.

Next, referring to a flowchart of FIG. 16, the procedure of the above-described recognition process is described.

The digital notebook application program 202 determines whether a plurality of blocks (handwriting blocks), which are obtained by executing a grouping process of a plurality of stroke data indicated by the time-series information of the target of the recognition process, are characters or not, and classifies all blocks into character blocks including characters and blocks including no character (step S41). The digital notebook application program 202 executes the above-described graphic recognition process and the above-described table recognition process with respect to each of the blocks including no character (step S42, S43). Then, the digital notebook application program 202 executes the character recognition process with respect to each character block (step S44).

In this manner, in the present embodiment, as a pre-process of the graphic recognition process and table recognition process, the character recognition process is executed for classifying all blocks into character blocks including characters and blocks including no character. Thereby, since a part which is determined to be a character can be excluded from the target of conversion of the above-described graphic/table conversion process, the recognition ratio in each of the graphic recognition process and table recognition process can be enhanced. In the character determination, for example, all blocks may be character-recognized, and blocks having a predetermined degree or more of similarity to characters may be determined to be character blocks. In this case, the process of step S44 in FIG. 16 is executed in step S41.

As has been described above, in the present embodiment, a plurality of handwritten strokes are stored as first time-series information in which a plurality of stroke data each including coordinate data series corresponding to points on the locus of each stroke are arranged in times series. Then, in the select process for selecting a process-target time-series information part from the first time-series information in accordance with a range designation operation which is executed on the touch-screen display, the process-target time-series information part is selected, with use of the first time-series information, from a first set of stroke data corresponding to strokes belonging to the designated range on the screen, which is designated by the range designation operation.

In many cases, on a handwritten document, other characters or graphics are handwritten over already handwritten characters or graphics. In the above-described select process, even in the case where a designated range includes not only a set of strokes of a certain handwritten character, but also a stroke of a subsequently added handwritten character or handwritten mark, the stroke of the subsequently added handwritten character or handwritten mark can be excluded. Thus, for example, the user can easily designate the process-target time-series information part by such a simple range designation operation as surrounding a part of a display page by a handwritten circle.

In addition, the above-described select process can be executed based on the presence/absence of continuity between stroke data. In this case, in the select process, a first set of stroke data corresponding to strokes belonging to a designated range on the screen, which is designated by the range designation operation, is extracted from the first time-series information. From the first set of stroke data, second stroke data, the handwriting timing of which is not successive to the handwriting timing of other stroke data in the first set of stroke data, is specified, and each stroke data in the first stroke data, excluding the second stroke data, is determined to be the process-target time-series information part.

Furthermore, in the present embodiment, each stroke data in the first time-series information may include time stamp information indicative of the handwriting timing of each point on the locus of the associated stroke. By using the time stamp information, for example, the difference in handwriting timing between strokes can be more precisely discriminated. In addition, by executing the above-described select process by using the time stamp information, the select process can be executed more precisely.

In the meantime, the above-described handwriting retrieve process and recognition processes (character recognition process, graphic recognition process and table recognition process) may be executed by the personal computer 1 or the server 2 on the Internet, which operates in cooperation with the tablet computer 10. Moreover, the above-described select process may be executed by the personal computer 1 or the server 2.

In the present embodiment, the case has been illustrated that the time stamp information is indicative of the handwriting timing, not in units of a stroke, but in units of a point in a stroke. However, the time stamp information may be indicative of the handwriting timing in units of a stroke. In this case, the time-series information may include a plurality of stroke data corresponding to a plurality of strokes, and time stamp information indicative of the handwriting timing of each of the strokes. In the time-series information with this structure, one time stamp information is associated with one stroke.

The various processes for a handwritten document in the embodiment can be realized by a computer program. Thus, the same advantageous effects as with the present embodiment can easily be obtained simply by installing the computer program into an ordinary computer including a touch-screen display through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a touch-screen display;
a first display process module configured to display, on a screen of the touch-screen display, a locus of each of a plurality of strokes which are handwritten by a handwriting input operation which is executed on the touch-screen display;
a storage module configured to store, in a storage medium, first time-series information including a plurality of stroke data corresponding to the plurality of strokes and indicating an order in which the plurality of strokes were handwritten;
a second display process module configured to display on the screen a locus corresponding to each of the plurality of strokes, based on the first time-series information; and
a select module configured to select a process-target time-series information part from the first time-series information in accordance with a range designation operation which is executed on the touch-screen display,
wherein the select module is configured to select, with use of the first time-series information, the process-target time-series information part from a first set of stroke data corresponding to strokes belonging to a designated range on the screen, which is designated by the range designation operation.

2. The electronic device of claim 1, wherein the select module is configured to specify second stroke data, which belongs to the first set of stroke data and whose handwriting timing is not successive to a handwriting timing of other stroke data in the first set of stroke data, and to determine each stroke data in the first set of stroke data excluding the second stroke data to be the process-target time-series information part.

3. The electronic device of claim 1, wherein each of the plurality of stroke data includes time stamp information indicative of a handwriting timing of each of points of an associated stroke.

4. The electronic device of claim 3, wherein the select module is configured to select the process-target time-series information part, based on at least either an arrangement of the first set of stroke data in the first time-series information, or the time stamp information included in each stroke data in the first set of stroke data.

5. The electronic device of claim 1, further comprising a retrieve module configured to retrieve, from the first time-series information, a time-series information part having a locus of a stroke, a degree of similarity of which to a locus of a stroke corresponding to a specific time-series information part designated as a retrieve key is a reference value or more.

6. The electronic device of claim 5, wherein the retrieve module is configured to display on the screen a retrieve key input area for handwriting a character string or a graphic which is to be set as a target of retrieval, and to use as the retrieve key a character string or a graphic which is handwritten in the retrieve key input area.

7. The electronic device of claim 5, wherein the retrieve module is configured to use as the retrieve key the process-target time-series information part which is selected by the select module.

8. The electronic device of claim 7, wherein the retrieve module is configured to retrieve, from other time-series information parts in the first time-series information excluding the time-series information part selected by the select module, a time-series information part having a locus of a stroke, a degree of similarity of which to a locus of a stroke corresponding to the selected time-series information part is a reference value or more.

9. The electronic device of claim 1, further comprising a character recognition process module configured to character-recognizing each of a plurality of blocks which are obtained by executing a grouping process of a plurality of stroke data indicated by the first time-series information such that stroke data corresponding to strokes, which are located close to each other and are successively handwritten, are classified into the same block, and to convert each of handwritten characters in the plurality of blocks to a character code.

10. The electronic device of claim 1, further comprising a graphic recognition module configured to execute a graphic recognition process for converting to one of a plurality of graphic objects a process-target block of a plurality of blocks which are obtained by executing a grouping process of a plurality of stroke data indicated by the first time-series information such that stroke data corresponding to strokes, which are located close to each other and are successively handwritten, are classified into the same block.

11. The electronic device of claim 10, wherein the graphic recognition module includes a determination module configured to determine whether the plurality of blocks are characters or not, and is configured to execute the graphic recognition process with respect to each of blocks other than characters.

12. The electronic device of claim 1, further comprising a table recognition module configured to recognize whether a process-target block of a plurality of blocks which are obtained by executing a grouping process of a plurality of stroke data indicated by the first time-series information such that stroke data corresponding to strokes, which are located close to each other and are successively handwritten, are classified into the same block, is a table shape including a combination of some line-shaped loci, and to convert, when the process-target block has been recognized as a table shape, the process-target block to a table object having the same numbers of vertical and horizontal elements as numbers of vertical and horizontal elements of the recognized table shape.

13. The electronic device of claim 12, wherein the table recognition module includes a determination module configured to determine whether the plurality of blocks are characters or not, and is configured to execute a table recognition process with respect to each of blocks other than characters.

14. An electronic device comprising:
a touch-screen display;
a first display process module configured to display, on a screen of the touch-screen display, a locus of each of a plurality of strokes which are handwritten by a handwriting input operation which is executed on the touch-screen display;
a storage module configured to store, in a storage medium, first time-series information including a plurality of stroke data corresponding to the plurality of strokes and time stamp information indicating a handwriting timing of each of the plurality of strokes; and
a second display process module configured to read out the first time-series information from the storage medium, and to display on the screen a locus corresponding to each of the plurality of strokes, based on the read-out first time-series information.

15. The electronic device of claim 14, further comprising a select module configured to select a process-target time-series information part from the first time-series information in accordance with a range designation operation which is executed on the touch-screen display,
wherein the select module is configured to select, with use of the time stamp information of the first time-series information, the process-target time-series information part from a first set of stroke data corresponding to strokes belonging to a designated range on the screen, which is designated by the range designation operation.

16. A handwritten document processing method of processing a handwritten document by an electronic device including a touch-screen display, comprising:
displaying, on a screen of the touch-screen display, a locus of each of a plurality of strokes which are handwritten by a handwriting input operation which is executed on the touch-screen display;
storing, in a storage medium, first time-series information including a plurality of stroke data corresponding to the plurality of strokes and indicating an order in which the plurality of strokes were handwritten;
reading out the first time-series information from the storage medium, and displaying on the screen a locus corresponding to each of the plurality of strokes, based on the read-out first time-series information; and
selecting a process-target time-series information part from the first time-series information in accordance with a range designation operation which is executed on the touch-screen display,
wherein said selecting includes selecting, with use of the first time-series information, the process-target time-series information part from a first set of stroke data corresponding to strokes belonging to a designated range on the screen, which is designated by the range designation operation.

17. The handwritten document processing method of claim 16, wherein said selecting includes specifying second stroke data, which belongs to the first set of stroke data and whose handwriting timing is not successive to a handwriting timing of other stroke data in the first set of stroke data, and determining each stroke data in the first set of stroke data excluding the second stroke data to be the process-target time-series information part.

18. A computer-readable, non-transitory storage medium having stored thereon a computer program which is executable by a computer comprising a touch-screen display, the computer program controlling the computer to execute functions of:
displaying, on a screen of the touch-screen display, a locus of each of a plurality of strokes which are handwritten by a handwriting input operation which is executed on the touch-screen display;
storing, in a storage medium, first time-series information including a plurality of stroke data corresponding to the plurality of strokes and indicating an order in which the plurality of strokes were handwritten;
reading out the first time-series information from the storage medium, and displaying on the screen a locus corresponding to each of the plurality of strokes, based on the read-out first time-series information; and
selecting a process-target time-series information part from the first time-series information in accordance with a range designation operation which is executed on the touch-screen display,
wherein said selecting includes selecting, with use of the first time-series information, the process-target time-series information part from a first set of stroke data corresponding to strokes belonging to a designated range on the screen, which is designated by the range designation operation.

19. The computer-readable, non-transitory storage medium of claim 18, wherein said selecting includes specifying second stroke data, which belongs to the first set of stroke data and whose handwriting timing is not successive to a handwriting timing of other stroke data in the first set of stroke data, and determining each stroke data in the first set of stroke data excluding the second stroke data to be the process-target time-series information part.
